(19) United States
(12) Patent Application Publication
(10) Pub. No.: US 2009/0275453 A1
(43) Pub. Date: Nov. 5, 2009

(54) Roller for Various Machines and Apparatus

(76) Inventor: Yu-Lang Wu, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/113,022

(22) Filed: Apr. 30, 2008

(51) Int. Cl. F16C 13/00

(52) U.S. Cl. 492/47

(57) ABSTRACT

A roller for various machines and apparatus includes at least one roller core having a hollow body and two opposite communicable open ends, and at least one end cap joined to at least one of the two opposite open ends of the roller core by way of friction welding. The end cap is provided on one of two opposite sides with an axially outward extended engaging section for inserting into the hollow body of the roller core, and an annular groove is provided around the engaging section. With the above arrangements, the roller can be easily produced at reduced manufacturing cost and having a reduced weight but increased structural strength.

### FIELD OF THE INVENTION

The present invention relates to a roller for various machines and apparatus, and more particularly to a roller that can be more easily produced at reduced cost and has a reduced weight but increased structural strength for use on various machines and apparatus.

### BACKGROUND OF THE INVENTION

Generally, the roller intended for business machines, sports equipment, and various mechanical rotary shafts includes a roller core 4 having a shaft hole 41 extending a full length of an axis of the roller core 4, as shown in FIG. 16. The shaft hole 41 is supported in the roller core 4 by a plurality of supporting ribs 42 radially extended between an outer wall surface of the shaft hole 41 and an inner wall surface of the roller core 4. Two pivot shafts 43 are connected at respective first ends to two open ends of the shaft hole 41. Each of the pivot shafts 43 is formed at the first end into an engaging section 431 corresponding to the shaft hole 41, so that the engaging section 431 may be inserted in and held to the shaft hole 41 in a tight-fit relation. A second end of the pivot shaft 43 opposite to the first end is therefore axially outward projected from an end of the roller core 4. The above-described conventional roller having a roller core 4 and a plurality of supporting ribs 42 is more suitably manufactured through aluminum extrusion and then finished by turning. Therefore, the manufacturing process of the roller of FIG. 16 is complicated and requires high manufacturing cost. Further, the pivot shafts 43 connected to the shaft hole 41 in the tight-fit relation tend to slide in and become loosened from the shaft hole 41.

FIG. 17 shows a second conventional roller, which includes a hollow roller core 5 having two open ends 51. Each of the two open ends 51 has an end cap 52 mounted thereto. The end cap 52 is provided at a first side formed into an insertion section 53 for correspondingly inserting into the open end 51, and at an opposite second side with a centered and axially outward extended pivot shaft 54. The end caps 52 are fixedly connected to the roller core 5 by welding along two joint lines between the end caps 52 and the open ends 51. The welding is usually implemented by laser welding, which requires not only expensive equipment but also more time to complete the welding to result in relatively high manufacturing cost, and is therefore not economical for use. Meanwhile, the welded portions would become raised from the surface of the roller core 5 near the two open ends 52, and must be turned to smooth them to meet actual application thereof. The turning would inevitably weaken the structural strength at the joint areas and produce pores at the welded portions. Electric plating solution tends to permeate into the pores on the roller to thereby adversely affect the subsequent electric plating and the quality of the finished product.

To overcome the problems in the above two conventional rollers, a third conventional roller as shown in FIG. 18 has been developed. As shown, the roller of FIG. 18 includes a hollow roller core 6 having two open ends 61. Each of the two open ends 61 has a flat end cap 7 friction-welded to an annular end wall at the open end 61. At least one of the two end caps 7 is provided with an air port 71, which may be sealed by inserting a plug 711 thereinto. The other end cap 7 is provided with a centered pivot shaft 72. While the roller shown in FIG. 18 may improve the rollers in FIGS. 16 and 17, scrap produced in the process of friction-welding the end caps 7 to the open ends 61 of the roller core 6 would fall into the hollow roller core 6 to produce noise when the roller is in use. Further, it is not easy to align the flat end caps 7 with the annular end walls at the open ends 61 of the hollow roller core 6 unless a precision tool is used. Therefore, the roller of FIG. 18 is not easily producible. Moreover, the end caps 7 are friction-welded to the roller core 6 without other stable supporting means between them. Therefore, the end caps 7 are subject to separation from the roller core 6 after the roller has been used over a long period of time.

Therefore, all the above-described three conventional rollers are not ideal in terms of their manufacturing process and actual condition in use.

### SUMMARY OF THE INVENTION

A primary object of the present invention is to provide a roller that can be more easily produced at reduced cost and has a reduced weight but increased structural strength for use on various machines and apparatus.

To achieve the above and other objects, the roller for various machines and apparatus according to the present invention includes at least one roller core having a hollow body and two communicable opposite ends, and at least one end cap joined to at least one of the two opposite ends of the roller core by way of friction welding. The end cap is provided on one of two opposite sides with an axially outward extended engaging section for inserting into the hollow body of the roller core, and an annular groove is provided around the engaging section.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a roller according to a first embodiment of the present invention;

FIG. 2 is an assembled and partially sectioned perspective view of the roller of FIG. 1;

FIG. 3 is a longitudinal sectional view of the roller of FIG. 1;

FIG. 4 is an exploded perspective view of a roller according to a second embodiment of the present invention;

FIG. 5 is an assembled and partially sectioned perspective view of the roller of FIG. 4;

FIG. 6 is a longitudinal sectional view of the roller of FIG. 4;

FIG. 7 is an exploded perspective view of a roller according to a third embodiment of the present invention;

FIG. 8 is an assembled perspective view of the roller of FIG. 7;

FIG. 9 is a longitudinal sectional view of the roller of FIG. 7;

FIG. 10 is an assembled and partially sectioned perspective view of a roller according to a fourth embodiment of the present invention;

FIG. 11 is a longitudinal sectional view of the roller of FIG. 10;

FIG. 12 is an assembled perspective view of a roller according to a fifth embodiment of the present invention;

FIG. 13 is a longitudinal sectional view of the roller of FIG. 12;

FIG. 14 is an assembled perspective view of a roller according to a sixth embodiment of the present invention;

FIG. 15 is a longitudinal sectional view of the roller of FIG. 14;

FIG. 16 is an exploded perspective view of a first conventional roller;

FIG. 17 is an exploded perspective view of a second conventional roller; and

FIG. 18 is an exploded perspective view of a third conventional roller.

### DETAILED DESCRIPTION OF THE PREFERRED EMBODIMENTS

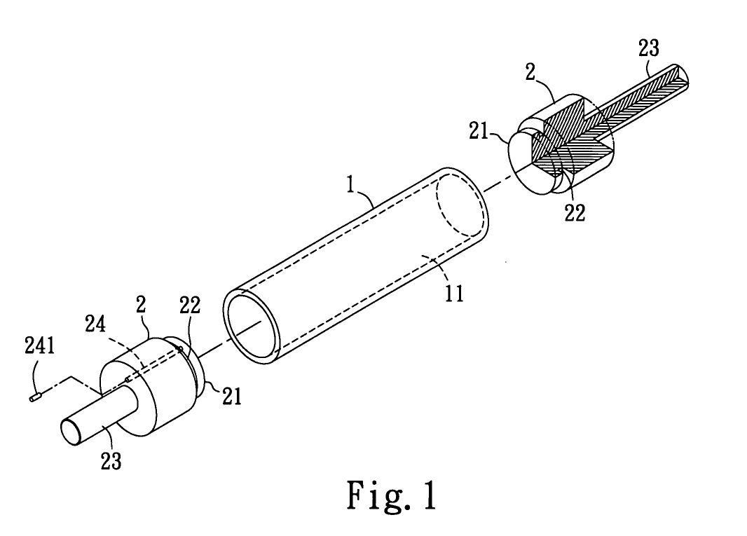

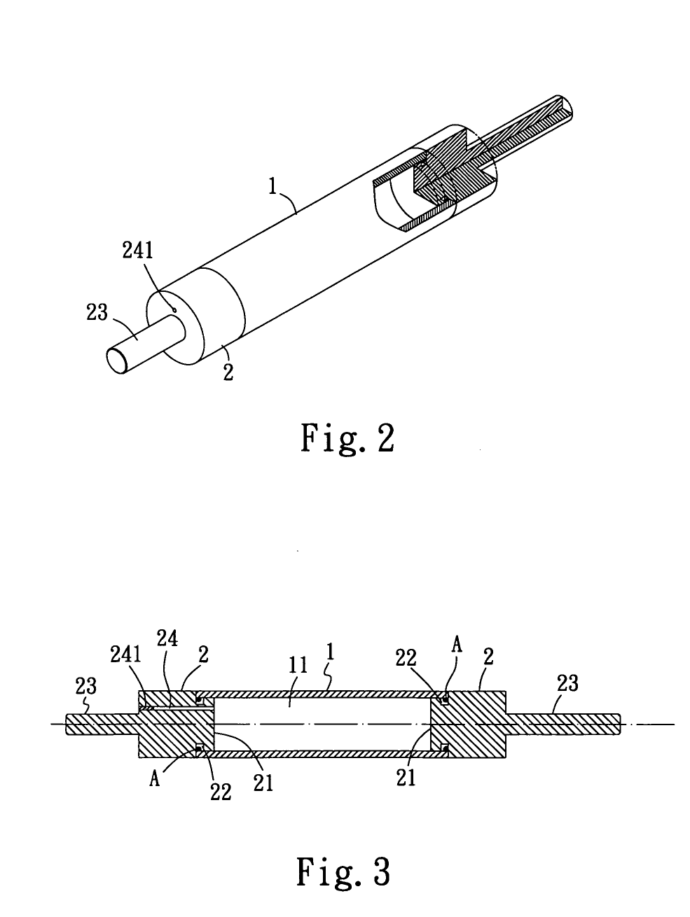

Please refer to FIG. 1 that is an exploded perspective view of a roller according to a first embodiment of the present invention, and to FIGS. 2 and 3 that are assembled perspective and longitudinal sectional views, respectively, of the roller of FIG. 1. As shown, the roller according to the first embodiment of the present invention includes a roller core 1 and two ends caps 2.

The roller core 1 includes a hollow body 11 having two communicable opposite ends. In the present invention, the roller core 1 may be a seamed or a seamless pipe.

The end caps 2 are separately joined to the two opposite open ends of the roller core 1. Each of the end caps 2 is integrally provided on a first side with an axially outward extended engaging section 21 having an annular groove 22 formed therearound, and on a second side opposite to the first side with an axially outward extended shaft 23. The end caps 2 each have an air port 24 provided thereon. The air ports 24 may be sealed using a plug 241 each.

To manufacture the roller of the first embodiment, the two end caps 2 are joined to the roller core 1 with the engaging sections 21 separately inserted into the two opposite open ends of the hollow body 11, and a suitable tool (not shown) is used to apply forces in two opposite directions to the end caps 2 and the roller core 1, so that the end caps 2 and the roller core 1 are rotated at high speed relative to one another, enabling the two end caps 2 to be friction-welded at respective first side to the two open ends of the roller core 1. When the end caps 2 and the roller core 1 are being friction-welded to one another, scrap A produced from the two ends of the roller core 1 in the friction welding process is received in the annular grooves 22 around the engaging sections 21 without falling into the hollow body 11 of the roller core 1. The scrap A received in the annular grooves 22 also helps in the tight connection of the end caps 2 to an inner wall surface of the hollow body 11 of the roller core 1. In the course of joining the end caps 2 to the roller core 1, air inside the roller core 1 may be discharged via the air ports 24 on the end caps 2. After the end caps 2 are firmly connected to the roller core 1, the air ports 24 are sealed by inserting the plugs 241 into the air ports 24.

By connecting the end caps 2 at the first side thereof to the two opposite open ends of the hollow body 11 of the roller core 1 through friction welding, the roller can be more easily manufactured at reduced cost and may have a reduced overall weight. Further, with the engaging sections 21 of the end caps 2 inserted in the hollow body 11 of the roller core 1, the end caps 2 and the roller core 1 may be joined with effectively enhanced torsion strength, tensile strength, and pull strength to achieve the purpose of increasing the whole structural strength of the roller.

Since the end caps 2 are friction-welded to the roller core 1, the roller core 1 and the end caps 2 may be the same material or different materials, depending on the types of machines or apparatus on which the roller is used. Therefore, the roller of the present invention may be used on various types of machines and apparatus, particularly various kinds of business machines, such as printers, copiers, fax machines, scanners, laminating machines, barcode printers, bill counters, bill validating machines, and automatic teller machines; sports equipment, such as running machines, and waist twisting machines; and mechanical rotary shafts, such as belt conveyors.

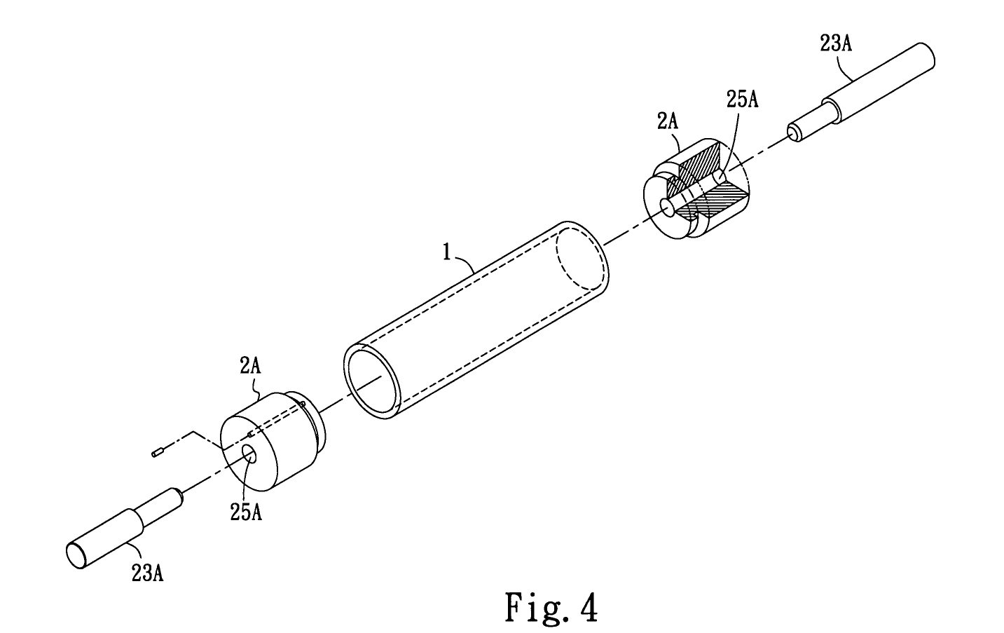

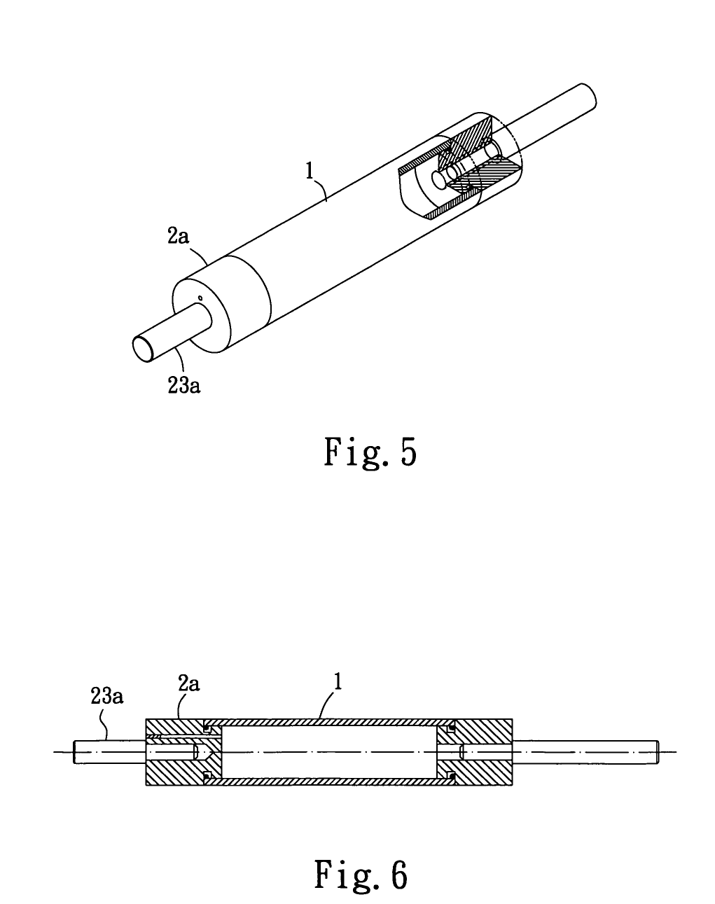

Please refer to FIG. 4 that is an exploded perspective view of a roller according to a second embodiment of the present invention, and to FIGS. 5 and 6 that are assembled perspective and longitudinal sectional views, respectively, of the roller of FIG. 4. As shown, the roller according to the second embodiment of the present invention includes a roller core 1 and two end caps 2a. The end cap 2a is generally structurally similar to the end cap 2 of the first embodiment, except for a connecting bore 25a formed on the second side thereof and a shaft 23a partially inserted in the connecting bore 25a. The end cap 2a is high-frequency heated for a predetermined time period or to a required temperature after or before it is friction-welded to the open end of the roller core 1, and an end of the shaft 23a is extended into the connecting bore 25a with another opposite end of the shaft 23a projected from the second side of the end cap 2a. When the end cap 2a is cooled down, the shaft 23a and the end cap 2a are tightly connected together due to the principle of thermal expansion and cold contraction. While the second embodiment of the present invention provides a different way for connecting the shaft to the end cap of the roller, the roller so produced has the same advantages as that in the first embodiment.

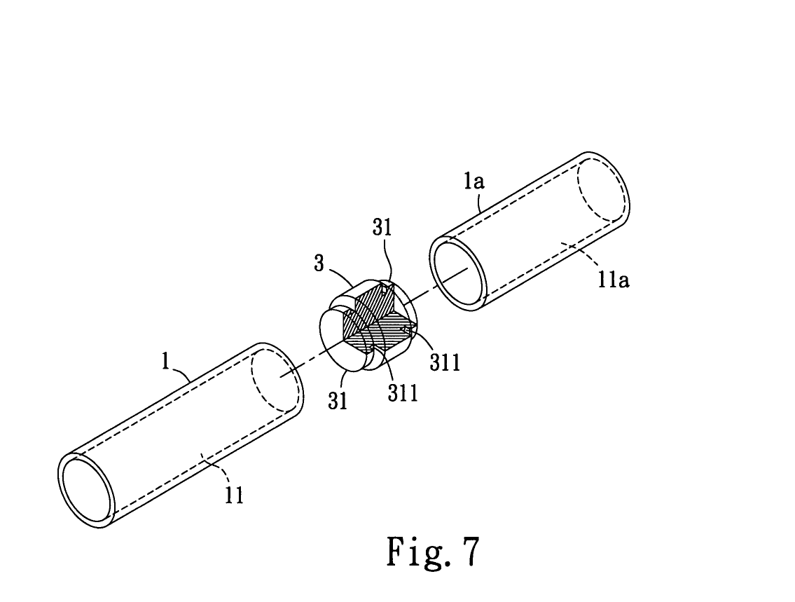

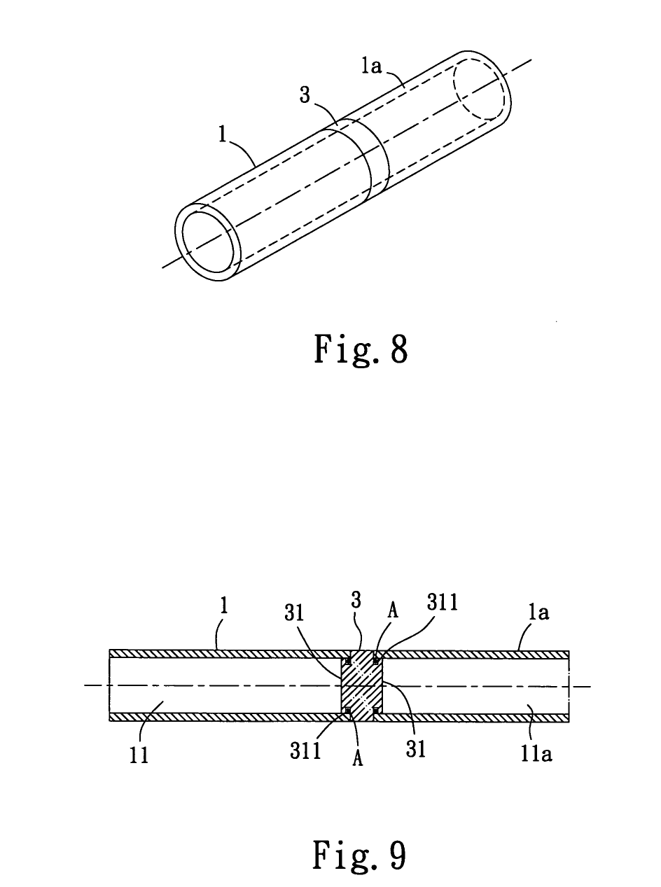

Please refer to FIG. 7 that is an exploded perspective view of a roller according to a third embodiment of the present invention, and to FIGS. 8 and 9 that are assembled perspective and longitudinal sectional views, respectively, of the roller of FIG. 7. As shown, the roller according to the third embodiment of the present invention includes two roller cores 1, 1a joined together end to end via a connector 3. The connector 3 is provided at two opposite ends with two axially outward extended coupling sections 31 for inserting into the hollow bodies 11, 11a of the two roller cores 1, 1a, and an annular groove 311 is provided around each of the two coupling sections 31. To connect the two roller cores 1, 1a together, the coupling sections 31 of the connector 3 are aligned with and then inserted into the hollow bodies 11, 11a of the two roller cores 1 and 1a via two facing open ends thereof. Thereafter, the coupling sections 31 of the connector 3 are friction-welded to the roller cores 1, 1a for the connector 3 to locate between and fixedly join to the two roller cores 1, 1a. Any scrap A produced in the process of friction welding is received in the annular grooves 311 around the coupling sections 31.

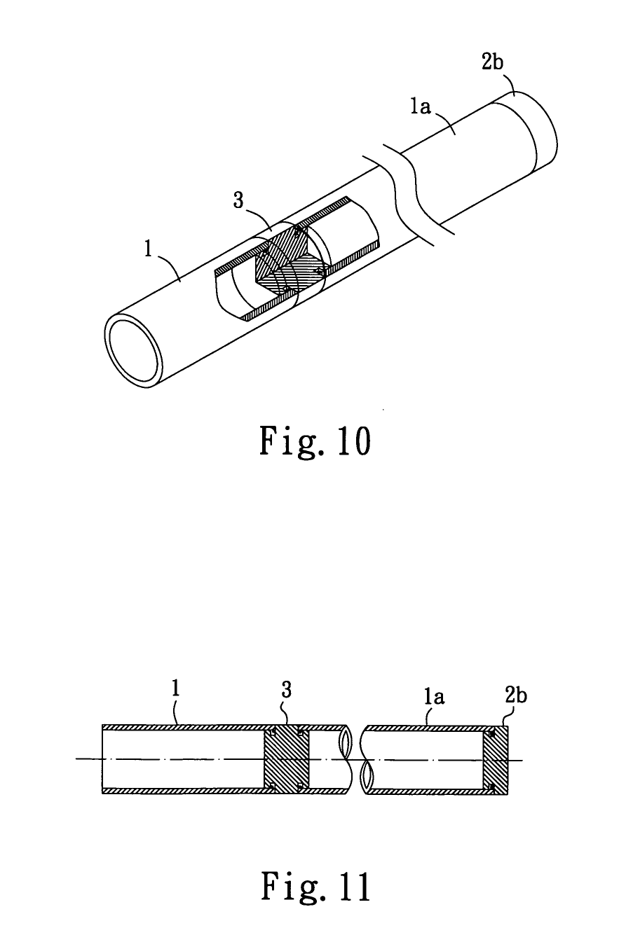

Please refer to FIGS. 10 and 11, in which a roller according to a fourth embodiment of the present invention is shown. The roller in the fourth embodiment is structurally similar to the third embodiment, except that one or both of the two open ends of the two joined roller cores 1, 1a facing away from each other have an end cap 2b mounted thereto to give the joined roller cores 1, 1a an increased structural strength. The end cap 2b is not necessarily provided with a shaft 23 or 23a like that in the first or the second embodiment while the roller according to the fourth embodiment may still have the same advantages as that in the first and second embodiments.

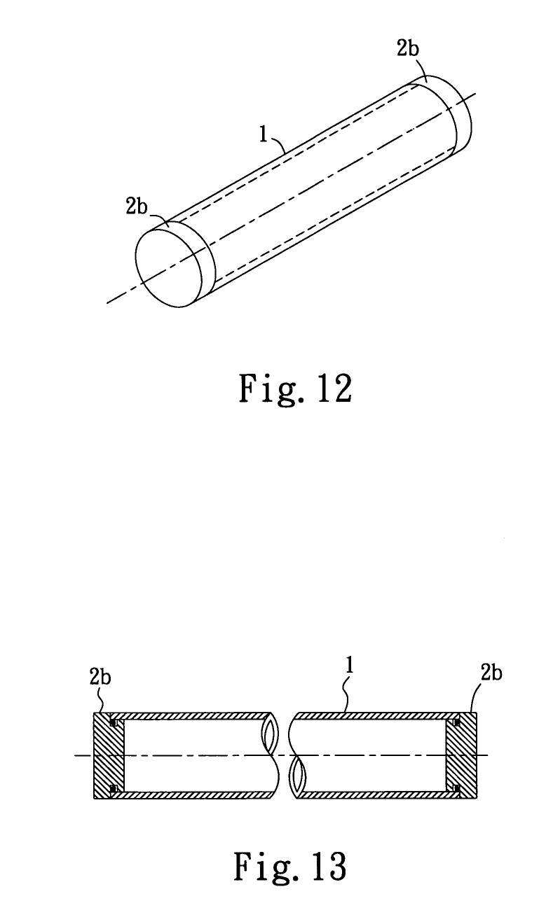

FIGS. 12 and 13 are perspective and longitudinal sectional views, respectively, of a roller according to a fifth embodiment of the present invention. As shown, the roller of the fifth embodiment includes a roller core 1 similar to that in the first and second embodiments, and two end caps 2b similar to that in the fourth embodiment for friction-welding to two open ends of the roller core 1. It is noted the end caps 2b are not provided with any shaft 23 or 23a as that in the first or second embodiment.

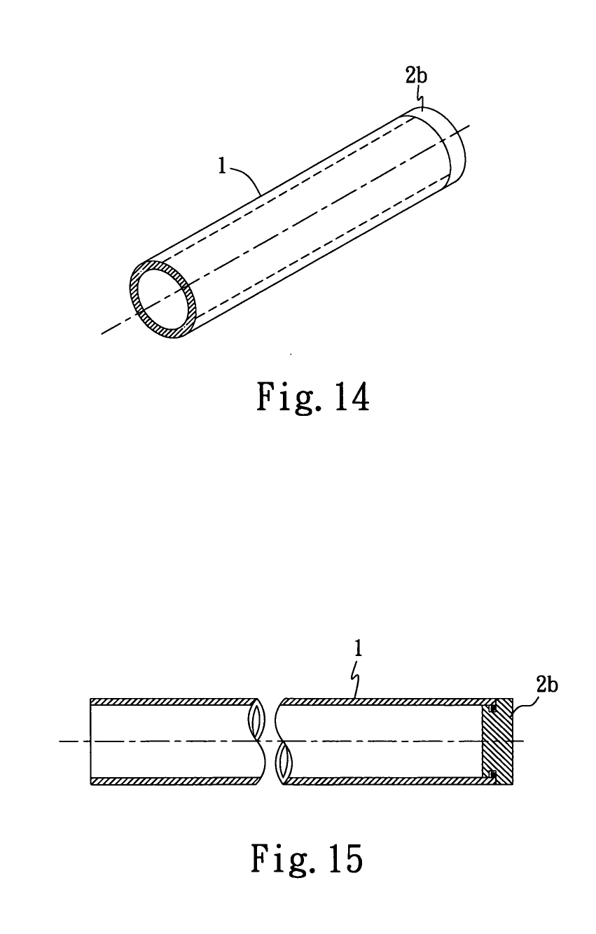

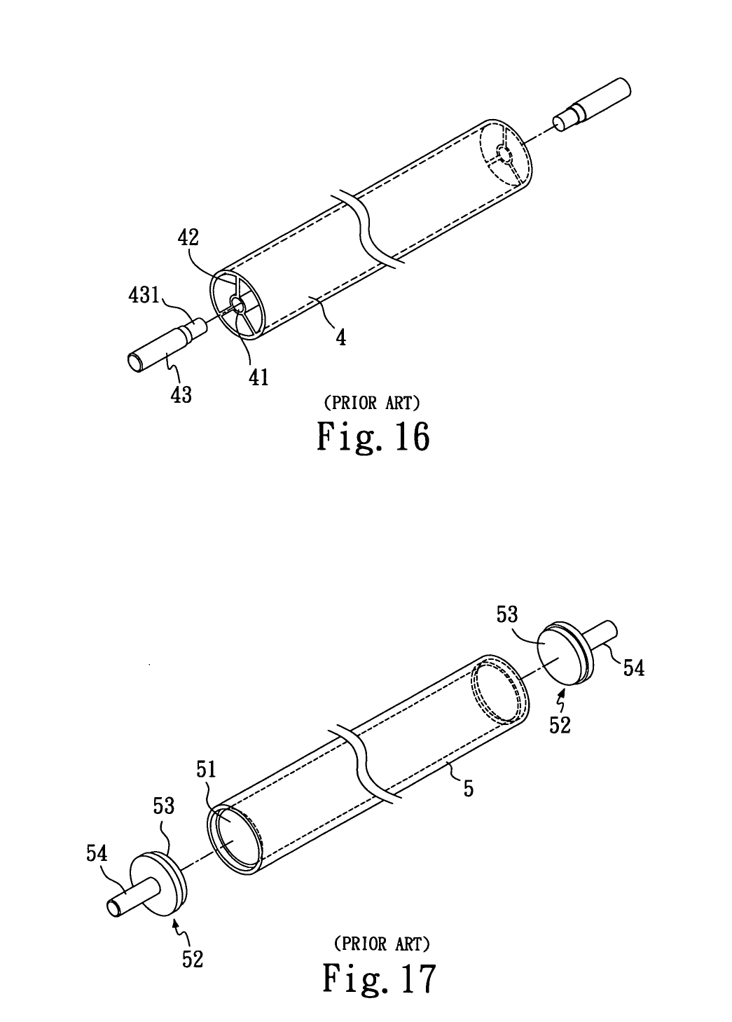

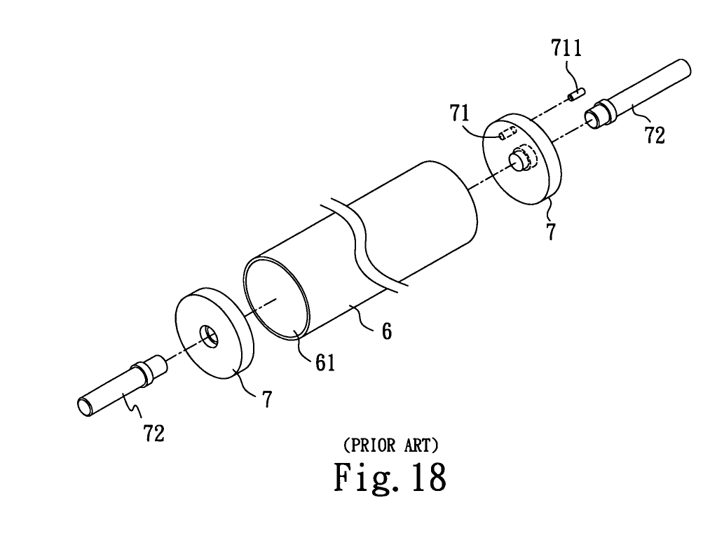

FIGS. 14 and 15 are perspective and longitudinal sectional views, respectively, of a roller according to a sixth embodiment of the present invention. As shown, the roller of the sixth embodiment is structurally similar to the fifth embodiment, except that only one of the two open ends of the roller core 1 is provided with the end cap 2b. The rollers in the fifth and sixth embodiments have the same advantages as that in the previous embodiments.

With the above arrangement, the roller according to the present invention may be more easily produced at reduced manufacturing cost while having enhanced structural strength. Therefore, the present invention is improved and more practical for use to meet consumers' requirements.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A roller for various machines and apparatus, comprising:
at least a roller core being a hollow body with two opposite communicable open ends; and
at least one end cap being provided on a first side with an engaging section for inserting into the hollow body of the roller core; and the end cap being fixedly joined to at least one of the two open ends of the roller core by way of friction welding, and having an annular groove provided around the engaging section.

2. The roller as claimed in claim 1, wherein the roller core is selected from the group consisting of a seamed pipe and a seamless pipe.

3. The roller as claimed in claim 1, wherein both of the two open ends of the roller core have one said end cap joined thereto, and wherein the end cap is integrally provided on a second side opposite to the first side with an axially outward extended shaft.

4. The roller as claimed in claim 1, wherein both of the two open ends of the roller core have one said end cap joined thereto, and wherein the end cap is provided on a second side opposite to the first side with a connecting bore, and a shaft is extended into the connecting bore when the end cap has been heated through high frequency heating.

5. The roller as claimed in claim 1, wherein two said roller cores are included and joined together end to end via a connector; the connector being provided at two opposite ends with two axially outward extended coupling sections for inserting into the hollow bodies of the two roller cores; and the connector being located between and fixedly joined to the two roller cores by way of friction welding, and having an annular groove provided around each of the two coupling sections.

6. The roller as claimed in claim 1, wherein the end cap is provided with an air port, which may be sealed with a plug.

7. The roller as claimed in claim 1, wherein only one of the two open ends of the roller core has the end cap joined thereto.

8. The roller as claimed in claim 1, wherein both of the two open ends of the roller core have the end cap joined thereto.
